(19) United States
(12) Patent Application Publication
(10) Pub. No.: US 2026/0218775 A1
(43) Pub. Date: Jul. 30, 2026

(54) VIBRATION-ISOLATING DEVICE

(71) Applicant: Toyo Tire Corporation, Itami-shi (JP)

(72) Inventors: Yuga Yokoyama, Itami-shi (JP); Takahiro Nakagaki, Itami-shi (JP)

(73) Assignee: Toyo Tire Corporation, Itami-shi (JP)

(21) Appl. No.: 19/426,638

(22) Filed: Dec. 19, 2025

(30) Foreign Application Priority Data
Dec. 27, 2024 (JP) 2024-232205

(51) Int. Cl. F16F 15/124; F16F 15/12

(52) U.S. Cl. CPC F16F 15/1245; F16F 15/1201

(57) ABSTRACT

Provided is a vibration-isolating device in which a distance between a first outer surface and a first inner surface (i.e., the width of a first hollow portion) at the center in the axial direction is 0.5 to 2.0 mm, and a distance between a second outer surface and a second inner surface (i.e., the width of a second hollow portion) at the center in the axial direction is 2.0 to 5.0 mm. The shapes of the first outer surface and the first inner surface are set such that the first outer surface and the first inner surface do not come into contact with each other within a range in which a prying angle is 17 degrees or less.

### BACKGROUND OF THE INVENTION

### 1. Field of the Invention

The present invention relates to a vibration-isolating device, and more particularly, to a vibration-isolating device that is less likely to cause abnormal noise at the time of prying deformation.

### 2. Description of the Related Art

In the related art, there is known a vibration-isolating device in which an outer peripheral surface of a shaft-shaped inner member and an inner peripheral surface of a tubular outer member are connected by a vibration-isolating base made of an elastic body. Examples of such a vibration-isolating device include a vibration-isolating device in which a first hollow portion and a second hollow portion, both extending through the vibration-isolating base in the axial direction of the inner member, are formed on both sides in the radial direction with the inner member interposed therebetween.

In a vibration-isolating device disclosed in Japanese Unexamined Patent Application Publication No. 2018-91462, the width (the dimension in the radial direction) of the first hollow portion is smaller than the width of the second hollow portion. With such a configuration, when a load in the radial direction is inputted to the vibration-isolating device, the timing at which the portions of the vibration-isolating base on both sides of the first hollow portion come into contact with each other to restrict deflection can be made earlier, and the timing at which the portions of the vibration-isolating base on both sides of the second hollow portion come into contact with each other to restrict deflection can be delayed.

However, in the related art, since the width of the first hollow portion is reduced, when the vibration-isolating base is subjected to prying deformation by tilting the inner member in the direction of the first hollow portion and the second hollow portion with respect to the outer member, the portions of the vibration-isolating base on both sides of the first hollow portion, which has a smaller width, tend to come into contact with each other. Such contact causes a problem in that abnormal noise is likely to occur due to contact of the vibration-isolating base with itself.

### SUMMARY OF THE INVENTION

The present invention has been made to solve the above-described problem, and it is an object of the present invention to provide a vibration-isolating device that is less likely to cause abnormal noise at the time of prying deformation.

In order to achieve the object described above, a vibration-isolating device according to a first aspect of the present invention includes: a shaft-shaped inner member extending along an axis line; a tubular outer member surrounding an outer peripheral side of the inner member; and a vibration-isolating base made of an elastic body, the vibration-isolating base connecting an outer peripheral surface of the inner member and an inner peripheral surface of the outer member. The vibration-isolating base has: a first hollow portion that extends through the vibration-isolating base in an axial direction; a second hollow portion that is located on an opposite side from the first hollow portion in a radial direction with the inner member interposed therebetween and that extends through the vibration-isolating base in the axial direction; a first outer surface that forms the outer member side of an inner wall of the first hollow portion; a first inner surface that forms the inner member side of the inner wall of the first hollow portion, wherein a distance between the first inner surface and the first outer surface at a center in the axial direction is set to 0.5 to 2.0 mm; a second outer surface that forms the outer member side of an inner wall of the second hollow portion; and a second inner surface that forms the inner member side of the inner wall of the second hollow portion, wherein a distance between the second inner surface and the second outer surface at the center in the axial direction is set to 2.0 to 5.0 mm. Shapes of the first outer surface and the first inner surface are set such that when the vibration-isolating base is subjected to prying deformation by tilting the inner member with respect to the outer member in a direction in which the first hollow portion and the second hollow portion are located, the first outer surface and the first inner surface do not come into contact with each other within a range in which a prying angle of the axis line of the inner member with respect to the axial direction of the outer member is 17 degrees or less.

In the vibration-isolating device according to the first aspect, the distance between the first outer surface and the first inner surface (i.e., the width of the first hollow portion) at the center in the axial direction is 0.5 to 2.0 mm. On the other hand, the distance between the second outer surface and the second inner surface (i.e., the width of the second hollow portion) at the center in the axial direction is 2.0 to 5.0 mm. By setting such distances, as in the related art, when a load in the radial direction is inputted to the vibration-isolating device, the timing at which the first outer surface and the first inner surface come into contact with each other to restrict deflection can be made earlier, and the timing at which the second outer surface and the second inner surface come into contact with each other to restrict deflection can be delayed. In such a vibration-isolating device, when the vibration-isolating base is subjected to prying deformation, the first outer surface and the first inner surface, which have a smaller distance therebetween, tend to come into contact with each other earlier. However, in the vibration-isolating device according to the present aspect, the shapes of the first outer surface and the first inner surface are set such that the first outer surface and the first inner surface do not come into contact with each other within a range in which the prying angle is 17 degrees or less. This allows abnormal noise to be less likely to occur due to their contact at the time of prying deformation.

A vibration-isolating device according to a second aspect achieves the following effect in addition to the effect achieved by the vibration-isolating device according to the first aspect. The first outer surface and the second outer surface are located outside a virtual cylindrical surface or on the virtual cylindrical surface, in which a radius of the virtual cylindrical surface is a radial distance from the axis line to a center of the first outer surface or the second outer surface in the axial direction, and a central axis of the virtual cylindrical surface is the axis line. The first inner surface and the second inner surface are located inside a virtual spherical surface which has the same radius as the virtual cylindrical surface, and a center of the virtual spherical surface is located on the axis line at a center of the inner member in the axial direction. Since the first inner surface and the second inner surface move around the center of the virtual spherical surface at the time of simple prying deformation, the first inner surface and the second inner surface do not get out from the virtual spherical surface. With such a configuration, it is possible to make the first outer surface and the first inner surface not contact each other and to make the second outer surface and the second inner surface not contact each other at the time of simple prying deformation. This allows abnormal noise to be less likely to occur due to their contact at the time of prying deformation.

A vibration-isolating device according to a third aspect achieves the following effect in addition to the effect achieved by the vibration-isolating device according to the second aspect. A plurality of axially extending projections extending in the axial direction are arranged on the first outer surface and the second outer surface in a peripheral direction. A plurality of peripherally extending projections extending in the peripheral direction are arranged on the first inner surface and the second inner surface in the axial direction. At the time of contact between the first outer surface and the first inner surface and at the time of contact between the second outer surface and the second inner surface, the plurality of axially extending projections and the peripherally extending projections having different directions are first brought into point contact with each other, and then the contact area thereof gradually expands. With such a configuration, the abnormal noise caused by their contact can be suppressed.

When the vibration-isolating base is manufactured with a mold that is opened toward both sides in the axial direction, the plurality of peripherally extending projections extending in the peripheral direction and arranged in the axial direction are formed by forced ejection. However, the first inner surface and the second inner surface, on which the peripherally extending projections are provided, are located inside the virtual spherical surface with predetermined distances to the first outer surface and the second outer surface at the center in the axial direction. Therefore, as the distance from the center in the axial direction increases, the first inner surface and the second inner surface tend to be more tilted with respect to the axis line than the first outer surface and the second outer surface. Since the peripherally extending projections formed by forced ejection are provided not on the first outer surface and the second outer surface with a smaller tilt, but on the first inner surface and the second inner surface with a larger tilt, the force required for forced ejection can be reduced. Therefore, workability can be improved when the vibration-isolating base is taken out from the mold.

A vibration-isolating device according to a fourth aspect achieves the following effect in addition to the effect achieved by any one of the vibration-isolating devices according to the first to third aspects. In a cross section including centers of the first outer surface and the first inner surface in the axial direction, an area of the vibration-isolating base excluding the first hollow portion in a region between the inner member and the outer member within a range obtained by projecting a portion where the first inner surface and the first outer surface face each other in the radial direction is 60% or more. Further, in a cross section including centers of the second outer surface and the second inner surface in the axial direction, an area of the vibration-isolating base excluding the second hollow portion in a region between the inner member and the outer member within a range obtained by projecting a portion where the second inner surface and the second outer surface face each other in the radial direction is 60% or more. As a result, when a load in the radial direction, which causes the first hollow portion or the second hollow portion to collapse, is inputted, excessive deformation of the vibration-isolating base can be suppressed, so that the durability of the vibration-isolating base can be secured.

### BRIEF DESCRIPTION OF THE DRAWINGS

FIG. 1 is a top view of a vibration-isolating device according to a first embodiment;

FIG. 2 is a cross-sectional view of the vibration-isolating device taken along line II-II in FIG. 1;

FIG. 3 is a cross-sectional view of the vibration-isolating device taken along line III-III in FIG. 1;

FIG. 4 is a cross-sectional view of the vibration-isolating device taken along line IV-IV in FIG. 2;

FIG. 5 is a cross-sectional view of the vibration-isolating device taken at the time of prying deformation;

FIG. 6 is a cross-sectional view of a vibration-isolating device according to a second embodiment; and

FIG. 7 is a cross-sectional view of the vibration-isolating device taken along line VII-VII in FIG. 6.

### DESCRIPTION OF THE PREFERRED EMBODIMENTS

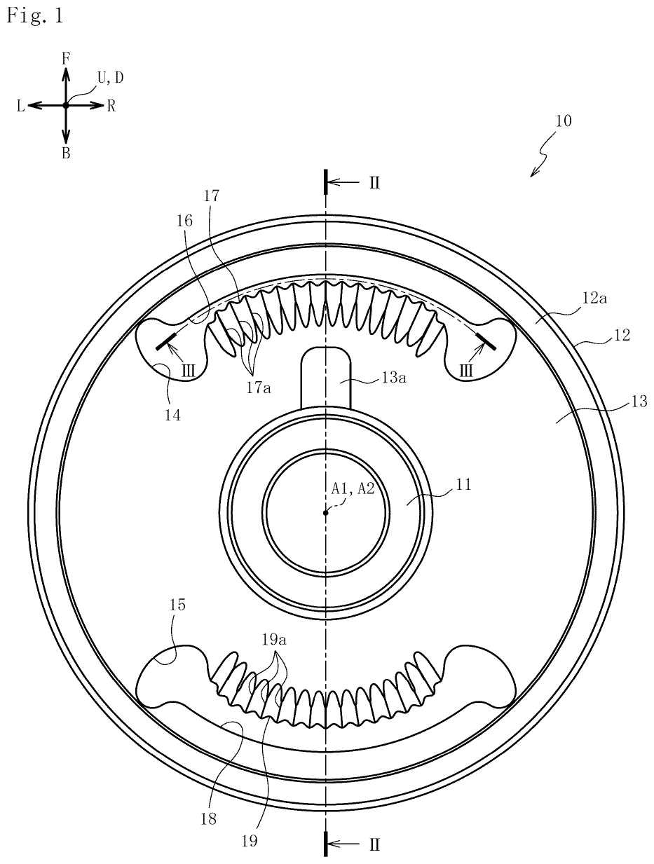

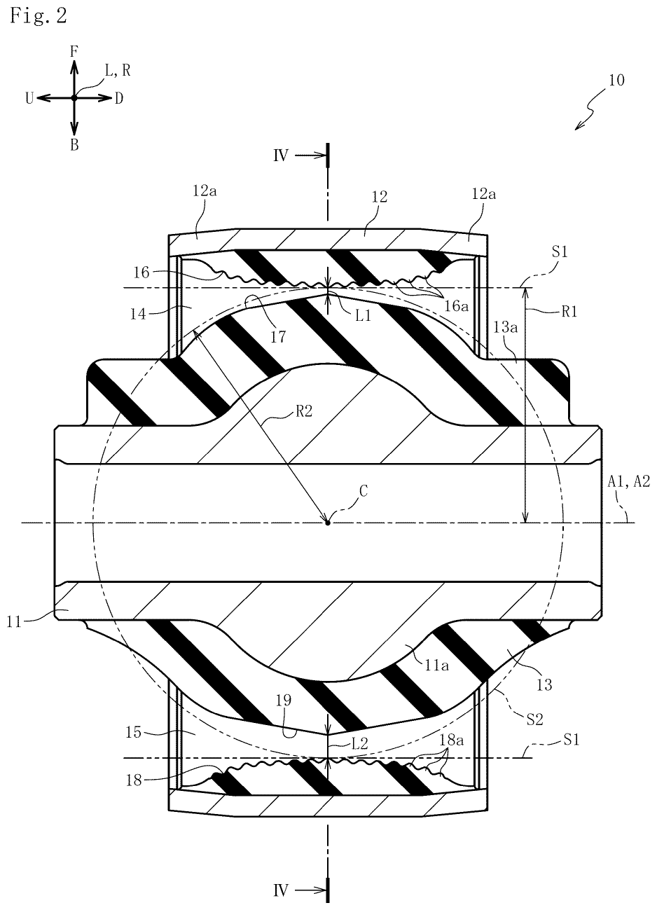

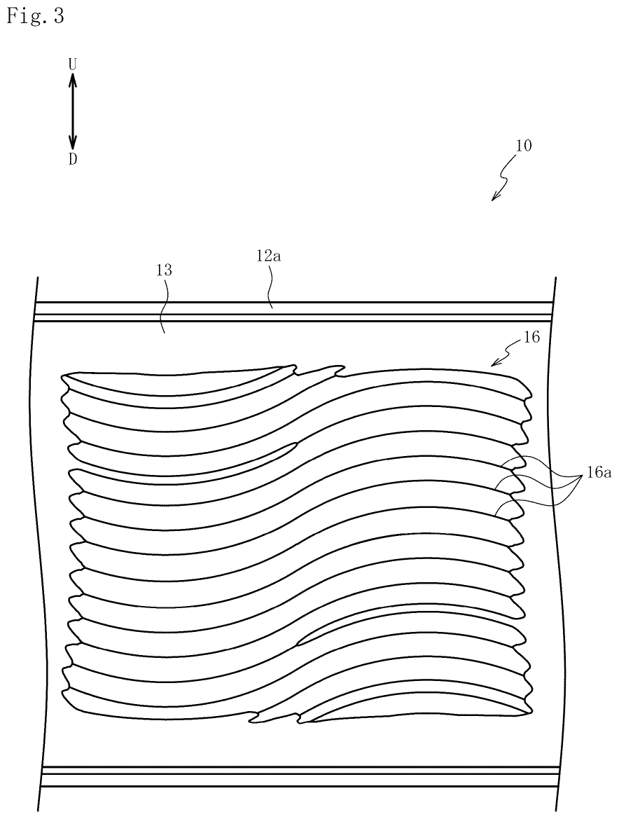

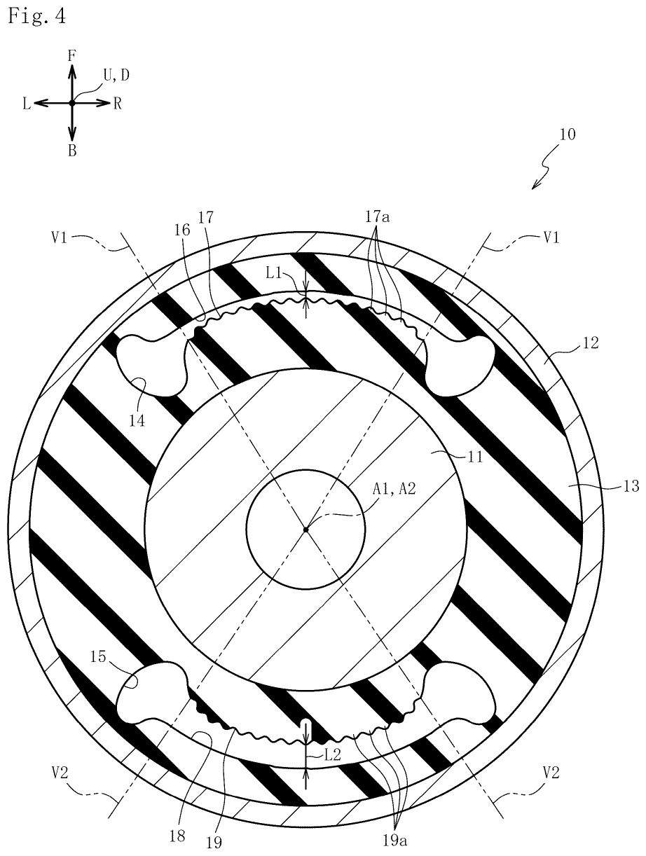

Hereinafter, preferred embodiments will be described with reference to the accompanying drawings. FIG. 1 is a top view of a vibration-isolating device 10 according to a first embodiment. FIG. 2 is a cross-sectional view of the vibration-isolating device 10 taken along line II-II in FIG. 1. FIG. 3 is a cross-sectional view of the vibration-isolating device 10 taken along line III-III in FIG. 1. FIG. 4 is a cross-sectional view of the vibration-isolating device 10 taken along line IV-IV in FIG. 2.

In each drawing, the arrow U, the arrow D, the arrow L, the arrow R, the arrow F, and the arrow B indicate the up direction, the down direction, the left direction, the right direction, the front direction, and the back direction, respectively, of the vibration-isolating device 10. The up-down direction, the left-right direction, and the front-back direction are perpendicular to each other. Note that these directions are set for convenience of description, and may coincide with or differ from the actual up-down direction and the like. Further, each of the vibration-isolating devices 10 in FIGS. 1 to 4 is shown in a no-load state in which no vibration is applied. In the description made using such drawings, the vibration-isolating device 10 in a no-load state is described unless otherwise specified.

As shown in FIGS. 1 and 2, the vibration-isolating device 10 is a vibration-isolating bushing for elastically coupling a vibration source side, such as an engine, a motor, or an arm of a suspension mechanism of a vehicle, with a vibration receiving side, such as a vehicle body. The vibration-isolating device 10 mainly includes a shaft-shaped inner member 11 extending along an axis line A1, a tubular outer member 12 extending along an axis line A2 and surrounding the outer peripheral side of the inner member 11, and a vibration-isolating base 13 made of an elastic body and connecting the inner member 11 and the outer member 12.

In a no-load state, the axis line A1 coincides with the axis line A2. Hereinafter, the direction of the axis line A1 and the direction of the axis line A2 are simply referred to as an axial direction. The vibration-isolating device 10 is provided in a vehicle with the axial direction as the up-down direction. The individual portions of the vibration-isolating device 10 are formed symmetrically with respect to the axis lines A1 and A2.

The inner member 11 is a substantially circular tubular member that surrounds the axis line A1 and that is made of a rigid material such as a steel material or an aluminum alloy. The inner member 11 is fixed to one of the vibration source side and the vibration receiving side with a bolt inserted into its inner peripheral side.

A convex portion 11a swollen outward in the axial direction is formed in a center portion of the inner member 11 in the axial direction. An outer peripheral surface of the convex portion 11a is formed in a substantially spherical shape with a point on the axis line A1 as a center C. The center C is located on the axis line A1 at the center of the inner member 11 in the axial direction. Further, the portions of the inner member 11 on both sides of the convex portion 11a in the axial direction each have an outer peripheral surface formed in a substantially cylindrical shape with the axis line A1 as the center. The inner peripheral surface of the inner member 11 is formed, over the entire length, in a substantially cylindrical shape with the axis line A1 as the center.

The outer member 12 is a substantially circular tubular member with the axis line A2 as the center, and is made of a rigid material such as a steel material or an aluminum alloy. The length of the outer member 12 in the axial direction is smaller than the length of the inner member 11 in the axial direction. The center of the outer member 12 in the axial direction coincides with the center of the inner member 11 in the axial direction. The outer member 12 is press-fitted and fixed to the inside of a tubular bracket, which is the other side of the vibration source side and the vibration receiving side.

Diameter-reduced portions 12a, which gradually decrease in diameter as the distance from the center in the axial direction increases, are formed in both end portions of the outer member 12 in the axial direction. The diameter-reduced portions 12a are formed by performing drawing processing after vulcanization molding of the vibration-isolating base 13. The diameter-reduced portions 12a facilitate press fitting of the outer member 12 to the inside of the bracket. In other words, press fitting of the outer member 12 to the bracket can be secured by the diameter-reduced portions 12a without providing chamfers at both ends of the outer member 12 in the axial direction. Further, deformation of the vibration-isolating base 13 that causes the vibration-isolating base 13 to escape to the outside in the axial direction along the inner peripheral surface of the outer member 12 can be suppressed by the diameter-reduced portions 12a.

The vibration-isolating base 13 is a member made of an elastic body such as rubber or thermoplastic elastomer. The vibration-isolating base 13 connects the outer peripheral surface of the inner member 11 and the inner peripheral surface of the outer member 12. The vibration-isolating base 13 is a vulcanization-molded product that is vulcanization-molded in the cavity of a mold (not shown) in which the inner member 11 and the outer member 12 are set; during the vulcanization molding, the vibration-isolating base 13 is vulcanization-bonded to the outer peripheral surface of the inner member 11 and the inner peripheral surface of the outer member 12.

The vibration-isolating base 13 has a first hollow portion 14 and a second hollow portion 15 that extend through the vibration-isolating base 13 in the axial direction. The first hollow portion 14 is provided on the front side with respect to the inner member 11, and extends in the peripheral direction. The second hollow portion 15 is provided on the back side with respect to the inner member 11, and extends in the peripheral direction. That is, the second hollow portion 15 is located on the opposite side from the first hollow portion 14 with the inner member 11 interposed therebetween in the radial direction.

The vibration-isolating base 13 includes a first outer surface 16, a first inner surface 17, a second outer surface 18, and a second inner surface 19. The first outer surface 16 forms the outer member 12 side of the inner wall of the first hollow portion 14. The first inner surface 17 forms the inner member 11 side of the inner wall of the first hollow portion 14. The second outer surface 18 forms the outer member 12 side of the inner wall of the second hollow portion 15. The second inner surface 19 forms the inner member 11 side of the inner wall of the second hollow portion 15.

These surfaces 16 to 19 (the first hollow portion 14 and the second hollow portion 15) are formed when the vibration-isolating base 13 is vulcanization-molded with the mold described above. In order to open the mold toward both sides from the center in the axial direction to remove a part of the mold from between the surfaces 16 to 19 after vulcanization molding, it is necessary to provide a draft angle (for example, basically 1 to 2 degrees or more) in that part of the mold. When the first outer surface 16 and the first inner surface 17 are formed with such a mold, the distance between the first outer surface 16 and the first inner surface 17 (i.e., the width of the first hollow portion 14 in the radial direction) becomes gradually greater as it extends from the center in the axial direction toward both ends. The tilt angle of the first outer surface 16 and the first inner surface 17 with respect to the axis lines A1 and A2 is substantially the same as the draft angle of the part of the mold that forms the first outer surface 16 and the first inner surface 17.

Similarly, with the draft angle of the mold, the distance between the second outer surface 18 and the second inner surface 19 (i.e., the width of the second hollow portion 15 in the radial direction) becomes gradually greater as it extends from the center in the axial direction toward both ends. The tilt angle of the second outer surface 18 and the second inner surface 19 with respect to the axis lines A1 and A2 is substantially the same as the draft angle of the part of the mold that forms the second outer surface 18 and the second inner surface 19.

As shown in FIGS. 2 and 4, in the present embodiment, a distance L1 between the first outer surface 16 and the first inner surface 17 at the center in the axial direction is set to 0.5 to 2.0 mm. That is, in both sides of the first hollow portion 14 in the radial direction, the portions where the distance L1 at the center in the axial direction is 0.5 to 2.0 mm are the first outer surface 16 and the first inner surface 17. In both end portions of the first hollow portion 14 in the peripheral direction, the width is greater than the distance L1, but both sides of such portions are not the first outer surface 16 or the first inner surface 17.

When the inner member 11 is displaced forward with respect to the outer member 12 by a load inputted to the vibration-isolating device 10 in the radial direction, the first hollow portion 14 collapses and the first outer surface 16 and the first inner surface 17 come into contact with each other, so that the deflection of the vibration-isolating base 13 due to the displacement is restricted. The timing for restricting the deflection when the first hollow portion 14 collapses is set according to the value of the distance L1.

In the present embodiment, a distance L2 between the second outer surface 18 and the second inner surface 19 at the center in the axial direction is set to 2.0 to 5.0 mm. That is, in both sides of the second hollow portion 15 in the radial direction, the portions where the distance L2 at the center in the axial direction is 2.0 to 5.0 mm are the second outer surface 18 and the second inner surface 19. In both end portions of the second hollow portion 15 in the peripheral direction, the width is greater than the distance L2, but both sides of such portions are not the second outer surface 18 or the second inner surface 19.

When the inner member 11 is displaced rearward with respect to the outer member 12 by a load inputted to the vibration-isolating device 10 in the radial direction, the second hollow portion 15 collapses and the second outer surface 18 and the second inner surface 19 come into contact with each other, so that the deflection of the vibration-isolating base 13 due to the displacement is restricted. The timing for restricting the deflection when the second hollow portion 15 collapses is set according to the value of the distance L2.

Since the distance L1 is smaller than the distance L2, the timing for restricting the deflection when the first hollow portion 14 collapses can be made relatively earlier, and the timing for restricting the deflection when the second hollow portion 15 collapses can be relatively delayed. For example, by arranging the vibration-isolating device 10 in a vehicle such that the first hollow portion 14 collapses under a load when the vehicle decelerates and the second hollow portion 15 collapses under a load when the vehicle accelerates, the timing for restricting both deflections can be appropriately set.

As shown in FIGS. 1 and 4, the first inner surface 17 is provided with a plurality of axially extending projections 17a projecting toward the first outer surface 16. The plurality of axially extending projections 17a (grooves between the axially extending projections 17a) each extend linearly in the axial direction, and are arranged in the peripheral direction of the first inner surface 17.

Similarly, the second inner surface 19 is provided with a plurality of axially extending projections 19a projecting toward the second outer surface 18. The plurality of axially extending projections 19a (grooves between the axially extending projections 19a) each extend linearly in the axial direction, and are arranged in the peripheral direction of the second inner surface 19.

As shown in FIGS. 2 and 3, the first outer surface 16 is provided with a plurality of peripherally extending projections 16a projecting toward the first inner surface 17. The plurality of peripherally extending projections 16a (grooves between the peripherally extending projections 16a) each wave in the axial direction while extending in the peripheral direction, and are arranged in the axial direction of the first outer surface 16.

The second outer surface 18 is provided with a plurality of peripherally extending projections 18a projecting toward the second inner surface 19. The plurality of peripherally extending projections 18a are formed in the same manner as the plurality of peripherally extending projections 16a shown in FIG. 3. That is, the plurality of peripherally extending projections 18a (grooves between the peripherally extending projections 18a) each wave in the axial direction while extending in the peripheral direction, and are arranged in the axial direction of the second outer surface 18.

The tilt angle of the first outer surface 16 and the tilt angle of the second outer surface 18 with respect to the axis lines A1 and A2 are the tilt angle of a surface formed by smoothly connecting the tips of the plurality of peripherally extending projections 16a and the tilt angle of a surface formed by smoothly connecting the tips of the plurality of peripherally extending projections 18a, respectively. Similarly, the tilt angle of the first inner surface 17 and the tilt angle of the second inner surface 19 with respect to the axis lines A1 and A2 are the tilt angle of a surface formed by smoothly connecting the tips of the plurality of axially extending projections 17a and the tilt angle of a surface formed by smoothly connecting the tips of the plurality of axially extending projections 19a, respectively.

As shown in FIGS. 2 and 4, when the first outer surface 16 and the first inner surface 17 come into contact with each other, first, the tips of the plurality of peripherally extending projections 16a and the plurality of axially extending projections 17a having different directions from each other come into point contact with each other. Then, the peripherally extending projections 16a and the axially extending projections 17a which have come into contact with each other collapse, and accordingly the contact area between the peripherally extending projections 16a and the axially extending projections 17a gradually expands. In such a manner, since the contact between the first outer surface 16 and the first inner surface 17 is buffered, abnormal noise due to such contact can be suppressed.

Further, since the plurality of peripherally extending projections 16a and the plurality of axially extending projections 17a extend in different directions respectively, when the peripherally extending projections 16a and the axially extending projections 17a collapse, air in the grooves between the peripherally extending projections 16a and the grooves between the axially extending projections 17a tends to escape to the outside. In addition, when the first outer surface 16 and the first inner surface 17 separate again after coming into contact with each other, air tends to enter the grooves between the peripherally extending projections 16a and the grooves between the axially extending projections 17a, so that it is less likely to cause a vacuum state. As a result, abnormal noise caused by air compression in the grooves and abnormal noise caused when air enters the grooves in a vacuum state can be suppressed.

Similarly, when the second outer surface 18 and the second inner surface 19 come into contact with each other, the tips of the plurality of peripherally extending projections 18a and the plurality of axially extending projections 19a having different directions from each other come into point contact with each other; then the peripherally extending projections 18a and the axially extending projections 19a collapse, and accordingly the contact area gradually expands. As a result, abnormal noise due to contact between the second outer surface 18 and the second inner surface 19 can be suppressed by buffering the contact and suppressing air compression.

Further, since the peripherally extending projections 16a and 18a wave in the axial direction while extending in the peripheral direction, when the axially extending projections 17a and 19a come into contact with the peripherally extending projections 16a and 18a, if the contact positions of the axially extending projections 17a and 19a with respect to the peripherally extending projections 16a and 18a are shifted in the peripheral direction, the contact positions are also shifted in the axial direction. Thus, in a case where the contact positions are more easily shifted, local occurrence of wear on the peripherally extending projections 16a and 18a and the axially extending projections 17a and 19a due to contact can be suppressed, as compared with a case where the contact positions are less easily shifted.

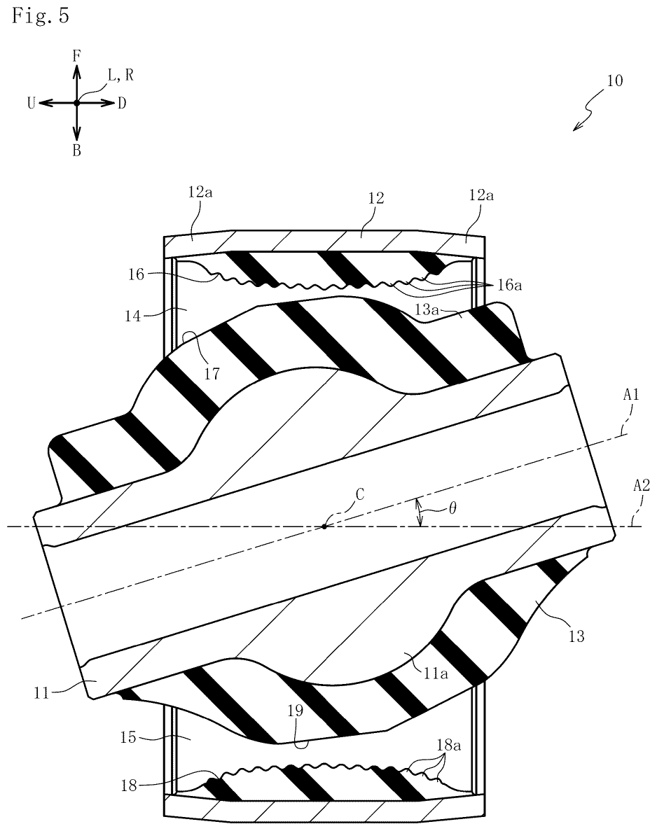

Next, the vibration-isolating device 10 at the time of prying deformation will be described with reference to FIG. 5. FIG. 5 is a cross-sectional view of the vibration-isolating device 10 taken at the time of prying deformation. Prying deformation means that the vibration-isolating base 13 is deformed by rotating the inner member 11 and the outer member 12 relative to each other around a radial axis passing through the center C. In particular, in the description of the present invention, the deformation of the vibration-isolating base 13 when the inner member 11 is tilted with respect to the outer member 12 in the directions of the first hollow portion 14 and the second hollow portion 15 (relatively rotated around an axis in the left-right direction) is described as prying deformation.

As shown in FIG. 5, the axis lines A1 and A2, which coincide in a no-load state in FIG. 2, are shifted around the center C due to prying deformation. The angle of the axis line A1 with respect to the axis line A2 (the axial direction of the outer member 12) is a prying angle θ.

As described above, in the vibration-isolating device 10 according to the present embodiment, the distance L2 is smaller than the distance L1. Therefore, at the time of prying deformation, it is less likely for the second outer surface 18 and the second inner surface 19 on both sides of the distance L2, which is a relatively larger distance, to contact each other, whereas it is more likely for the first outer surface 16 and the first inner surface 17 on both sides of the distance L1, which is a relatively smaller distance, to contact each other. When the first outer surface 16 and the first inner surface 17 contact each other, abnormal noise may occur.

For example, when the respective surfaces 16 to 19 are formed such that the draft angle (the tilt angle with respect to the axis lines A1 and A2) of the mold is about 2 degrees, if the distance L1, which is the smaller distance, is 0.5 to 2.0 mm, the first outer surface 16 and the first inner surface 17 may contact each other when the prying angle θ is about 15 degrees or less. However, sometimes specifications may require that the first outer surface 16 and the first inner surface 17 do not contact each other when the prying angle θ is 17 degrees or less while the distance L1 is maintained at 0.5 to 2.0 mm.

Therefore, in the present embodiment, both sides of the first inner surface 17 in the axial direction are cut when the draft angle is about 2 degrees. Specifically, the shapes of the first outer surface 16 and the first inner surface 17 are set such that the first outer surface 16 and the first inner surface 17 do not come into contact with each other within a range in which the prying angle θ is 17 degrees or less. This allows abnormal noise to less likely to occur due to contact between the first outer surface 16 and the first inner surface 17 at the time of prying deformation.

The shapes of the first outer surface 16, the first inner surface 17, and the like will be described in more detail with reference back to FIG. 2. The first outer surface 16 is formed so as to be located outside a virtual cylindrical surface S1 or on the virtual cylindrical surface S1, wherein the radius R1 of the virtual cylindrical surface S1 is the radial distance from the axis lines A1 and A2 to the center of the first outer surface 16 or the second outer surface 18 in the axial direction, and the central axis of the virtual cylindrical surface S1 is the axis lines A1 and A2. The second outer surface 18 is formed symmetrically with respect to the axis lines A1 and A2 with respect to the first outer surface 16, and is formed so as to be located outside the virtual cylindrical surface S1 or on the virtual cylindrical surface S1.

A virtual spherical surface S2 is set; the virtual spherical surface S2 has a radius R2, which is the same as the radius R1 of the virtual cylindrical surface S1, and the center of the virtual spherical surface S2 is the center C. The first inner surface 17 is formed so as to be located inside the virtual spherical surface S2. The second inner surface 19 is also formed so as to be located inside the virtual spherical surface S2.

Thus, the first inner surface 17 and the second inner surface 19 move around the center C of the virtual spherical surface S2 at the time of simple prying deformation (at the time when only prying deformation occurs in the vibration-isolating base 13), so that the first inner surface 17 and the second inner surface 19 do not get out from the virtual spherical surface S2. Thus, it is possible to make the first outer surface 16 and the first inner surface 17 not contact each other and to make the second outer surface 18 and the second inner surface 19 not contact each other at the time of simple prying deformation. This allows abnormal noise to be less likely to occur due to their contact at the time of prying deformation.

Both the first inner surface 17 and the second inner surface 19 are formed so as to gradually approach the virtual spherical surface S2 from the center in the axial direction (the positions of the distances L1 and L2) toward both sides in the axial direction, and then leave away from the virtual spherical surface S2 along the way. That is, the tilt angles of the first inner surface 17 and the second inner surface 19 with respect to the axis lines A1 and A2 are each relatively small in the vicinity of the center in the axial direction and relatively large on both sides in the axial direction, respectively. Thus, when a load is inputted in the front-back direction, the contact area can be increased early from the start of contact between the first outer surface 16 and the first inner surface 17 and from the start of contact between the second outer surface 18 and the second inner surface 19 in the vicinity of the center in the axial direction, which has a relatively small tilt angle. As a result, the deflection of the vibration-isolating base 13 with respect to the load inputted in the front-back direction can be restricted early from the start of contact.

Further, the vibration-isolating base 13 is provided with a stopper portion 13a for restricting excessive prying deformation. The stopper portion 13a is a rectangular parallelepiped portion disposed outside the outer member 12 (between the first outer surface 16 and the first inner surface 17) in the axial direction and on the front side of the outer peripheral surface of the inner member 11. The size of the stopper portion 13a is set such that the stopper portion 13a contacts the first outer surface 16 when the prying angle θ becomes a predetermined value larger than 17 degrees (for example, 30 degrees). By such contact, excessive prying deformation in which the prying angle θ becomes the predetermined value or more can be restricted, so that the durability of the vibration-isolating base 13 can be improved.

In the cross section taken at the center in the axial direction shown in FIG. 4, a pair of virtual lines V1 are set, the pair of virtual lines V1 respectively passing through both ends of a portion where the first outer surface 16 and the first inner surface 17 face each other in the peripheral direction (i.e., the first hollow portion 14 excluding the wide portions) and the axis lines A1 and A2. In the cross section taken at the center in the axial direction, it is preferable that the area of the vibration-isolating base 13 excluding the first hollow portion 14 in the region between the inner member 11 and the outer member 12 within a range inside the pair of virtual lines V1 (i.e., a range obtained by projecting the portion where the first outer surface 16 and the first inner surface 17 face each other in the radial direction) is 60% or more. That is, it is preferable that the area of the first hollow portion 14 is less than 40%.

In the present embodiment, in a case where the draft angle is about 2 degrees, the volume of the vibration-isolating base 13 between the first hollow portion 14 and the inner member 11 is reduced by cutting both sides of the first inner surface 17 in the axial direction. If the volume is excessively reduced, when the inner member 11 is displaced forward with respect to the outer member 12 due to the input of a load in the radial direction, which causes the first hollow portion 14 to collapse, it becomes difficult to restrict such displacement. Thus, the vibration-isolating base 13 is excessively deformed, so that the durability of the vibration-isolating base 13 may deteriorate. In contrast, if the area of the vibration-isolating base 13 in the above range is 60% or more in the cross section taken at the center in the axial direction, the excessive deformation of the vibration-isolating base 13 can be suppressed when a load in the radial direction, which causes the first hollow portion 14 to collapse, is inputted, so that the durability of the vibration-isolating base 13 can be ensured.

Further, in the cross section taken at the center in the axial direction, a pair of virtual lines V2 are set, the pair of virtual lines V2 respectively passing through both ends of a portion where the second outer surface 18 and the second inner surface 19 face each other in the peripheral direction (i.e., the second hollow portion 15 excluding the wide portions) and the axis lines A1 and A2. In the cross section taken at the center in the axial direction, it is preferable that the area of the vibration-isolating base 13 excluding the second hollow portion 15 in the region between the inner member 11 and the outer member 12 within a range inside the pair of virtual lines V2 (i.e., a range obtained by projecting the portion where the second outer surface 18 and the second inner surface 19 face each other in the radial direction) is 60% or more. That is, it is preferable that the area of the second hollow portion 15 is less than 40%. In such a case, as with the first hollow portion 14 side, excessive deformation of the vibration-isolating base 13 can be suppressed when a load in the radial direction, which causes the second hollow portion 15 to collapse, is inputted, so that the durability of the vibration-isolating base 13 can be ensured.

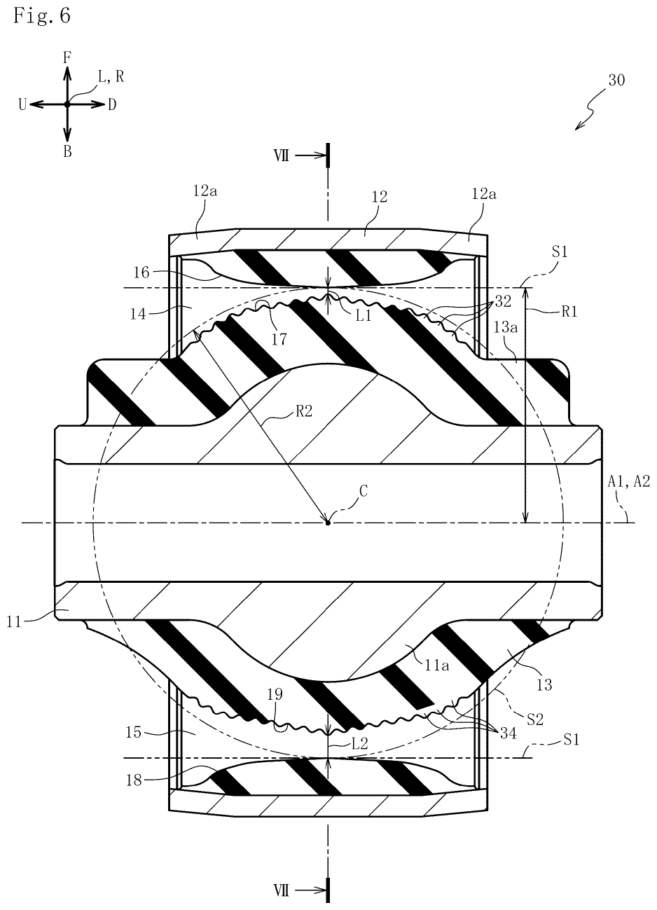

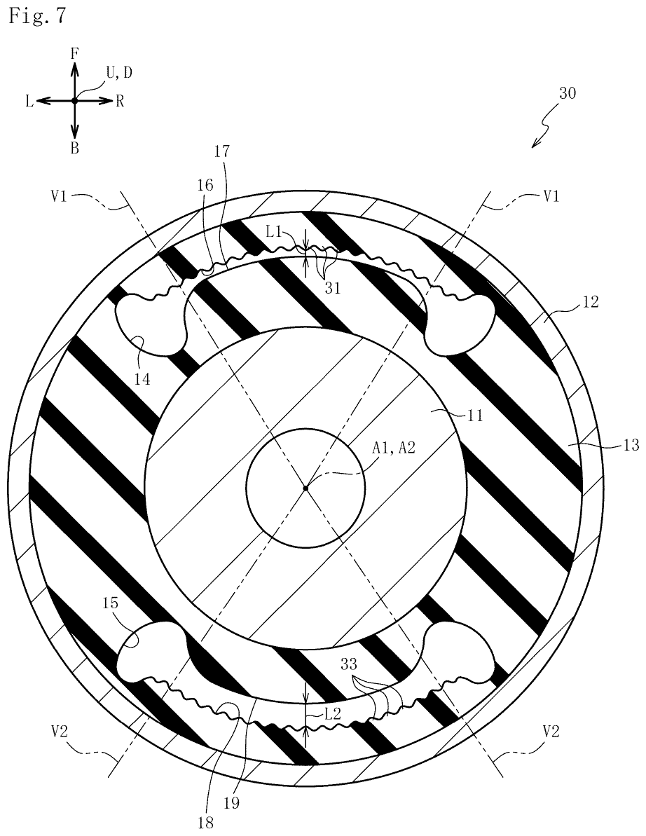

Next, a second embodiment will be described with reference to FIGS. 6 and 7. In the first embodiment, a case where the peripherally extending projections 16a and 18a are provided on the first outer surface 16 and the second outer surface 18, respectively, and the axially extending projections 17a and 19a are provided on the first inner surface 17 and the second inner surface 19, respectively, has been described. In contrast, in the second embodiment, a case where such projections are arranged reversely will be described. Note that the same components as those in the first embodiment are denoted by the same reference numerals and the description thereof will be omitted.

FIG. 6 is a cross-sectional view of a vibration-isolating device 30 according to the second embodiment. FIG. 7 is a cross-sectional view of the vibration-isolating device 30 taken along line VII-VII in FIG. 6. The vibration-isolating device 30 is provided with axially extending projections 31 on the first outer surface 16 instead of the peripherally extending projections 16a, and is provided with axially extending projections 33 on the second outer surface 18 instead of the peripherally extending projections 18a, as compared with the vibration-isolating device 10 according to the first embodiment.

In addition, the vibration-isolating device 30 is provided with peripherally extending projections 32 on the first inner surface 17 instead of the axially extending projections 17a, and is provided with peripherally extending projections 34 on the second inner surface 19 instead of the axially extending projections 19a, as compared with the vibration-isolating device 10 according to the first embodiment. Other configurations of the vibration-isolating device 30 are the same as those of the vibration-isolating device 10 according to the first embodiment.

The axially extending projections 31 are each a projection that projects from the first outer surface 16 toward the first inner surface 17, and extends linearly in the axial direction. The plurality of axially extending projections 31 are arranged in the peripheral direction of the first outer surface 16. The axially extending projections 33 are each a projection that projects from the second outer surface 18 toward the second inner surface 19, and extends linearly in the axial direction. The plurality of axially extending projections 33 are arranged in the peripheral direction of the second outer surface 18.

The peripherally extending projections 32 are each a projection that projects from the first inner surface 17 toward the first outer surface 16, and waves in the axial direction while extending in the peripheral direction. The plurality of peripherally extending projections 32 are arranged in the axial direction of the first inner surface 17. The peripherally extending projections 34 are each a projection that projects from the second inner surface 19 toward the second outer surface 18, and waves in the axial direction while extending in the peripheral direction. The plurality of peripherally extending projections 34 are arranged in the axial direction of the second inner surface 19.

As described above, the vibration-isolating device 30 is formed by reversing the arrangement of the axially extending projections 31 and 33 and the peripherally extending projections 32 and 34 with respect to the first embodiment, and basically achieves substantially the same effect as the vibration-isolating device 10 of the first embodiment. However, new effects achieved by such reversed arrangement will be described below.

When the vibration-isolating base 13 is manufactured in a mold that is to be opened toward both sides from the center in the axial direction, the plurality of peripherally extending projections 32 and 34 extending in the peripheral direction and arranged in the axial direction are formed by forced ejection. The first inner surface 17 and the second inner surface 19 on which the peripherally extending projections 32 and 34 are provided are located inside the virtual spherical surface S2 after the distances L1 and L2 between the first outer surface 16 and the second outer surface 18 in the center in the axial direction are determined.

Therefore, the first inner surface 17 and the second inner surface 19 are more tilted with respect to the axis lines A1 and A2 than the first outer surface 16 and the second outer surface 18 as the distance from the center in the axial direction increases. Since the peripherally extending projections 32 and 34 formed by forced ejection are provided not on the first outer surface 16 and the second outer surface 18 with a relatively smaller tilt but on the first inner surface 17 and the second inner surface 19 with a relatively larger tilt, the force required for forced ejection can be reduced. Therefore, workability can be improved when the vibration-isolating base 13 is taken out from the mold.

The present invention has been described based on the embodiments, but it can be readily understood that the present invention is not limited to the above embodiments and that various improvements and modifications are possible within the scope of the present invention without departing from its spirit.

For example, the shapes, materials, and numerical values described in the above embodiments are merely examples; it is certainly possible to use other shapes, materials, and numerical values. The vibration-isolating devices 10 and 30 may alternatively be left-right asymmetrical. Also, the peripherally extending projections 16a, 18a, 32, and 34 and the axially extending projections 17a, 19a, 31, and 33 may be omitted.

The shape of the inner member 11 is not limited to a tubular shape, and may be a rod shape in which the hole on the inner peripheral side is not provided. The cross section of the outer peripheral surface of the inner member 11 is not limited to a substantially circular cross section perpendicular to the axis line A1, but may alternatively be an elliptical or polygonal cross section. The convex portion 11a of the inner member 11 may be omitted, and a portion of the outer peripheral surface of the inner member 11 may be depressed. The shape of the outer member 12 is not limited to a circular tubular shape, but may alternatively be an oval tubular shape or a polygonal tubular shape; and a portion of the outer member 12 in the axial direction may be swollen or depressed. Further, the diameter-reduced portion 12a may be omitted.

In the above embodiments, a case where the vibration-isolating devices 10 and 30 are mounted on a vehicle with the axial direction as the up-down direction has been described, but the present invention is not necessarily limited to such a case. The vibration-isolating devices 10 and 30 may be mounted on objects other than the vehicle. Further, the vibration-isolating devices 10 and 30 may be disposed such that the axial direction is in the front-back direction or the left-right direction of a vehicle or the like.

### DESCRIPTION OF REFERENCE NUMERALS

10, 30 vibration-isolating device
11 inner member
12 outer member
13 vibration-isolating base
14 first hollow portion
15 second hollow portion
16 first outer surface
16a, 18a, 32, 34 peripherally extending projection
17 first inner surface
17a, 19a, 31, 33 axially extending projection
18 second outer surface
19 second inner surface
A1, A2 axis line
L1, L2 distance
S1 cylindrical surface
S2 spherical surface

What is claimed is:

1. A vibration-isolating device comprising:
a shaft-shaped inner member extending along an axis line;
a tubular outer member surrounding an outer peripheral side of the inner member; and
a vibration-isolating base made of an elastic body, the vibration-isolating base connecting an outer peripheral surface of the inner member and an inner peripheral surface of the outer member,
wherein
the vibration-isolating base has:
a first hollow portion that extends through the vibration-isolating base in an axial direction;
a second hollow portion that is located on an opposite side from the first hollow portion in a radial direction with the inner member interposed therebetween and that extends through the vibration-isolating base in the axial direction;
a first outer surface that forms the outer member side of an inner wall of the first hollow portion;
a first inner surface that forms the inner member side of the inner wall of the first hollow portion, wherein a distance between the first inner surface and the first outer surface at a center in the axial direction is set to 0.5 to 2.0 mm;
a second outer surface that forms the outer member side of an inner wall of the second hollow portion; and
a second inner surface that forms the inner member side of the inner wall of the second hollow portion, wherein a distance between the second inner surface and the second outer surface at the center in the axial direction is set to 2.0 to 5.0 mm, and
shapes of the first outer surface and the first inner surface are set such that when the vibration-isolating base is subjected to prying deformation by tilting the inner member with respect to the outer member in a direction in which the first hollow portion and the second hollow portion are located, the first outer surface and the first inner surface do not come into contact with each other within a range in which a prying angle of the axis line of the inner member with respect to the axial direction of the outer member is 17 degrees or less.

2. The vibration-isolating device according to claim 1, wherein
the first outer surface and the second outer surface are located outside a virtual cylindrical surface or on the virtual cylindrical surface, wherein a radius of the virtual cylindrical surface is a radial distance from the axis line to a center of the first outer surface or the second outer surface in the axial direction, and a central axis of the virtual cylindrical surface is the axis line, and
the first inner surface and the second inner surface are located inside a virtual spherical surface which has the same radius as the virtual cylindrical surface, wherein a center of the virtual spherical surface is located on the axis line at a center of the inner member in the axial direction.

3. The vibration-isolating device according to claim 2, wherein
a plurality of axially extending projections extending in the axial direction are arranged on the first outer surface and the second outer surface in a peripheral direction, and
a plurality of peripherally extending projections extending in the peripheral direction are arranged on the first inner surface and the second inner surface in the axial direction.

4. The vibration-isolating device according to claim 1, wherein
in a cross section including centers of the first outer surface and the first inner surface in the axial direction, an area of the vibration-isolating base excluding the first hollow portion in a region between the inner member and the outer member within a range obtained by projecting a portion where the first inner surface and the first outer surface face each other in the radial direction is 60% or more, and
in a cross section including centers of the second outer surface and the second inner surface in the axial direction, an area of the vibration-isolating base excluding the second hollow portion in a region between the inner member and the outer member within a range obtained by projecting a portion where the second inner surface and the second outer surface face each other in the radial direction is 60% or more.
